(19) United States
(12) Patent Application Publication
(10) Pub. No.: US 2005/0002107 A1
(43) Pub. Date: Jan. 6, 2005

(54) Erecting resin lens array and method of manufacturing the same

(76) Inventor: Hiroyuki Nemoto, Osaka (JP)

Correspondence Address: RATNERPRESTIA, P O BOX 980, VALLEY FORGE, PA, 19482-0980, US

(21) Appl. No.: 10/874,931

(22) Filed: Jun. 23, 2004

(30) Foreign Application Priority Data
Jul. 1, 2003 (JP) 2003-270,057

(51) Int. Cl. G03C 8/00; G02B 27/10

(52) U.S. Cl. 359/626

(57) ABSTRACT

The present invention provides a method of manufacturing a resin lens plate being a little in variation in thickness and characteristic. The method forms a resin plate with grooves by means of an extrusion molding method or a casting method. Further, it forms light absorbing films (light shading films) in the grooves of the formed resin plate with grooves, forms convex micro-lenses on the surfaces of the plate by means of a hot-embossing method using a fixed metal mold and a movable metal mold each having spherical micro-depressions arranged regularly at specified intervals on it, and thereby provides a resin lens plate having spherical convex micro-lenses arranged regularly at specified intervals.

### BACKGROUND OF THE INVENTION

1. Field of the Invention

The present invention relates to a method of manufacturing a resin lens plate for forming an erecting resin lens array to be used in an image forming device and the like.

2. Description of the Related Art

An injection molding method has been used up to now as a method of manufacturing a resin lens plate. An injection molding method is a method of injecting and filling a liquefied resin into metal molds, cooling and hardening the resin and transferring the shapes of the metal molds to the resin, thereby manufacturing a resin lens plate. The injection molding method has a higher throughput in comparison with other molding methods and is suitable for mass production and cost reduction.

In recent years, it has been promoted to make larger the area of an image to be handled in an image forming device, make wider the angle of field of the image and make higher the resolution of it. As the number of resin lens plates to form an erecting resin lens array is increased in order to make wider the angle of field of an image and make the resolution of it higher, the thickness of each resin lens plate is made thinner in case that the resin lens array is limited in thickness.

In a conventional injection molding method, when resin is injected into metal molds and spread inside the metal molds, the resin becomes uneven in its cooled state due to the difference in cooling rate among the respective parts inside the metal molds depending on the shapes of the metal molds, the distance from the inlet for injecting the resin, and the like. Therefore, a resin lens plate is made uneven in thickness or deformed due to a residual strain in it. And in case of molding a thin plate, since resin is difficult to spread in metal molds, a conventional injection molding method has been unsuitable for manufacturing a thin and large-area plate. Such an injection molding method is good at molding of a resin plate being diagonally 17 inches or less in area and 2.0 mm or more in thickness, and having a design pattern on at least one surface of it. When a plate is thinner in thickness than this, a distance in the direction of injection (flow length) is made shorter.

In case that the thickness of a plate is 1 mm, the tolerance in thickness is ±10 μm and the width of molding is 350 mm, the flow length being moldable is about 100 mm in a conventional injection molding method and about 200 mm in a compression injection molding method. When the thickness is made thinner, the flow length is made shorter. The thickness of a resin lens plate required is 0.8 mm. Even if resin is injected from a long-side film gate, the flow length is about 50 mm and an injection molding method which provides a large-area molded product and a high throughput is made less in advantage.

An object of the present invention is to provide a method of manufacturing a resin lens plate being less in deformation, variation in thickness and variation in property by solving the above-mentioned problems.

### SUMMARY OF THE INVENTION

The present invention is a method of manufacturing a resin lens plate in which spherical or aspherical convex micro-lenses are arranged regularly at specified intervals on at least one surface of it, said method forming a resin plate by means of an extrusion molding method or a casting method and then forming said convex micro-lenses on the formed resin plate by means of a hot-embossing method. And the present invention is a method of manufacturing a resin lens plate in which spherical or aspherical convex micro-lenses are arranged regularly at specified intervals on at least one surface of it, said method forming a resin plate with grooves by means of a casting method and forming light absorbing films in the grooves of the formed resin plate and then forming the convex micro-lenses on the resin plate having light absorbing films formed in its grooves by means of a hot-embossing method.

### BRIEF DESCRIPTION OF THE DRAWINGS

FIG. 1 is a plan view of a resin lens plate formed by a manufacturing method according to the present invention.

FIG. 2 is a sectional view taken along line A-A of FIG. 1.

FIG. 3 shows a resin plate with grooves formed by an extrusion molding method or a casting method.

FIG. 4 shows a resin plate with grooves having light absorbing films formed in its grooves.

FIG. 5 shows a pair of Ni (nickel) metal molds to be used in a hot-embossing process.

FIG. 6 shows points of measurement of difference in percentage of contraction of a lens plate.

FIG. 7 shows points of measurement of difference in thickness of a lens plate.

### DETAILED DESCRIPTION OF THE PREFERRED EMBODIMENTS

The present invention provides a method of manufacturing a resin lens plate by means of a hot-embossing method. While an injection molding method produces a difference in density in resin in a process of injecting and cooling the resin, a hot-embossing method is not liable to produce a difference in density in resin and produces no difference in thickness and percentage of contraction in a resin lens plate. Therefore, it is advantageous in that it is possible to reduce variation in lens pitch, variation in thickness and deformation of a resin lens plate, and make the resin lens plate larger in area.

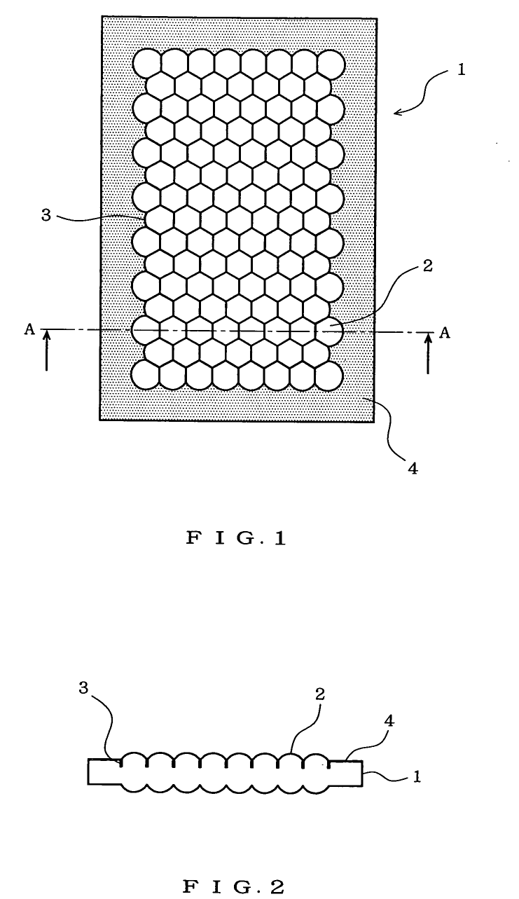

FIG. 1 is a plan view of a resin lens plate formed by a manufacturing method according to the present invention. A resin lens plate 1 shown in FIG. 1 is rectangular and has spherical or aspherical convex micro-lenses 2 arranged on a lens forming area in the middle of it. The convex micro-lenses 2 are formed on each surface of the resin lens plate 1. The convex micro-lenses 2 formed on the resin lens plate 1 may be either of spherical lenses and aspherical lenses. In the following embodiment, it is assumed that spherical lenses are formed. And convex micro-lenses 2 may be formed on only one surface of the lens plate 1.

The convex micro-lenses 2 each are hexagonal and are arranged in a zigzag arrangement (a hexagonal arrangement) in which they are alternately arranged in the direction parallel with an outer side of the resin lens plate 1. Individual lenses are densely arranged so as to be in contact with one another.

As shown in FIG. 1, it is preferable to embed a light absorbing film (light shading film) 3 along a perpendicular bisector of the line segment tying the centers of convex micro-lenses 2 adjacent to each other on the resin lens plate 1. It is preferable to form a light absorbing film 4 also on an area through which light not contributing to an image formation on the image plane passes, said area being other than the lens forming area on the resin lens plate 1.

FIG. 2 is a sectional view taken along line A-A of FIG. 1 and shows a state where a light absorbing film is embedded along a perpendicular bisector of the line segment tying the centers of convex micro-lenses 2 adjacent to each other.

Since a partition wall for partitioning imaging spaces of lenses adjacent to each other is formed by a light absorbing film 3 formed as described above, the resin lens plate 1 can effectively remove a stray light.

Next, a method of manufacturing a resin lens plate according to the present invention is described.

First, a resin plate 5 with grooves being 1.0 mm in thickness and ±0.1 mm in tolerance as shown in FIG. 3 is formed by a casting method. A cycloolefin-based resin is used as resin to be formed. The resin plate 5 may contain a material having a function of reducing ultraviolet rays and/or infrared rays. Further, a low-reflection coating may be formed on a surface of the resin plate 5. The low-reflection coating is intended to reduce the reflectance and uses a fluorine-based resin film. In this case a resin plate with grooves is formed by a casting method, but in case of requiring no groove a resin plate can be formed by an extrusion molding method.

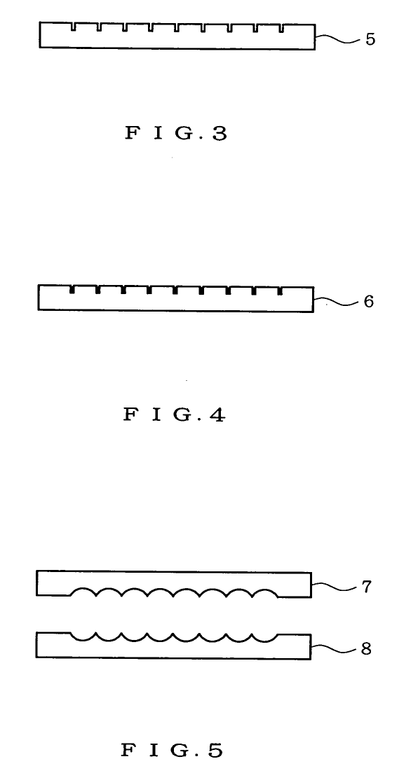

Next, as shown in FIG. 4, a resin plate 6 with grooves having light absorbing films formed in the grooves is made. Concretely, a paint containing carbon is applied to the whole surface of the resin plate and light absorbing film are left in the grooves by a method of wiping away the paint before the paint is dried, or the like. Since it is desirable to shade the light not contributing to an image formation as much as possible, a light absorbing film is also formed on an area other than an area expected to have lenses formed on it.

Next, Ni (nickel) metal molds 7 and 8 having spherical micro-depressions formed on them for a hot-embossing process as shown in FIG. 5 are made. The above-mentioned resin plate 6 with grooves is placed on a hot-embossing machine in which the Ni metal molds 7 and 8 are arranged so that their patterned faces are opposite to each other and one metal mold is used as a fixed mold and the other metal mold is used as a movable mold, and then the resin plate 6 with grooves is vacuum-compressed at about 200° C. In order to selectively make the lens plate concave or convex in face shape, the rate of cooling may be changed or the difference in temperature may be provided between the fixed metal mold and the movable metal mold at the time of cooling. In such a way, a resin lens plate having lenses each being 0.392 mm in diameter and 0.5 mm in radius of curvature, and having a hexagonal arrangement structure of 0.48 mm in lens pitch and a lens forming area of 2.4 mm in width was obtained. And the difference in plate thickness was less than 1% (0.88 mm in thickness and ±0.01 mm in tolerance), and the tolerance in alignment of lenses of the obverse and reverse faces was ±0.02 mm.

And the present invention forms light shading films in areas including grooves other than lenses after forming a resin plate with grooves by means of a casting method and before forming lenses by means of a hot-embossing method, thereby makes the light shading resin enter the grooves and performs a hot-embossing method in this state, thereby closes the grooves by fusing the surface of resin (also fusing the grooves at the same time) and thus may provide a structure confining the above-described light shading films inside the resin plate.

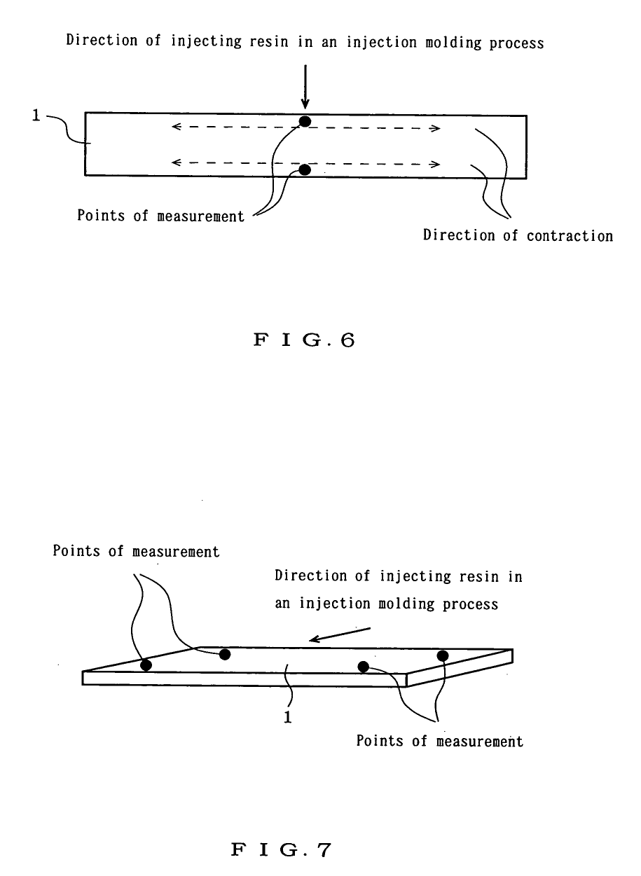

FIG. 6 shows the points of measurement of the difference in percentage of contraction of a resin lens plate. In FIG. 6, an arrow of a solid line shows the direction of injection of resin at the time of making a resin lens plate by means of an injection molding method and an arrow of a dashed line shows the direction of contraction of the resin lens plate at the time of making the resin lens plate by means of the injection molding method. The points of measurement are both end portions in the short side direction in the middle in the long side direction of the resin lens plate 1. The difference in percentage of contraction of both end portions in the short side direction in the middle in the long side direction of the resin lens plate 1 made by a manufacturing method of the present invention was less than 0.1%.

FIG. 7 shows the points of measurement of the difference in thickness of a resin lens plate. In FIG. 7, an arrow of a solid line shows the direction of injection of resin at the time of making a resin lens plate by means of an injection molding method. The points of measurement are both end portions in the short side direction in both end portions in the long side direction of the resin lens plate 1. The difference in thickness of both end portions in the short side direction in both end portions in the long side direction of the resin lens plate 1 made by a manufacturing method of the present invention was less than 1%.

An erecting resin lens array to be used in an image forming device and the like is made by arranging at least two resin lens plates formed as described above opposite to each other. In case of making an erecting resin lens array by arranging three formed resin lens plates opposite to one another, although depending on flare light to be prevented, it is the most preferable to form light absorbing films on areas other than lenses of lens faces [2] and [4] out of the total six lens faces including the obverse and reverse faces (the respective lens faces are assumed to be lens faces [1], [2], [3], [4], [5] and [6] in order of incidence of light) and it is the next preferable to form light absorbing films on areas other than lenses of lens faces [2], [4] and [6].

And a slit of 1.0 mm in opening width is formed at half a working distance from the lens area. It is preferable that the inner wall of the slit has a light absorbing function. Or it is preferable to form the slit itself out of a light absorbing material.

At the time of placing a test chart of 12 Lp/mm in spatial frequency at a working distance of 3 mm and measuring the resolution in order to examine the optical performance of an erecting resin lens array made, a resolution of 60% in MTF was obtained. And the image plane was a little in ghost and flare, and a good imaging characteristic was obtained. Further, the angular aperture (angle of incidence) measured by a laser light showed ±15°.

As described above, a method of manufacturing a resin lens plate of the present invention is characterized by making a resin plate by means of a conventional method such as an extrusion molding method, a casting method or the like and forming a lens portion by means of a hot-embossing method. The present invention makes it possible to manufacture a resin lens plate being thin in thickness and large in area as well as a little in deformation and a little in variation in thickness and characteristic. And the present invention makes it possible to manufacture a resin plate to be the base by means of an extrusion molding method or a casting method being excellent in productivity. Further, the present invention makes it possible to easily add a function of reducing ultraviolet rays and/or infrared rays to a lens plate by mixing a material having said function in resin to be a material for the lens plate.

1. A method of manufacturing a resin lens plate in which spherical or aspherical convex micro-lenses are arranged regularly at specified intervals on at least one surface of it, said method comprising the steps of;
forming a resin plate by means of an extrusion molding method or a casting method, and
forming said convex micro-lenses on the formed resin plate by means of a hot-embossing method.

2. A method of manufacturing a resin lens plate in which spherical or aspherical convex micro-lenses are arranged regularly at specified intervals on at least one surface of it, said method comprising the steps of;
forming a resin plate with grooves by means of a casting method,
forming light absorbing films in the grooves of the formed resin plate, and
forming said convex micro-lenses on said resin plate having light absorbing films formed in said grooves by means of a hot-embossing method.

3. A method of manufacturing a resin lens plate according to claim 1 or 2, wherein;
said resin plate is equal to or more than said resin lens plate in thickness.

4. A method of manufacturing a resin lens plate according to claim 1 or 2, wherein;
said resin plate contains a material having a function of reducing ultraviolet rays and/or infrared rays.

5. A method of manufacturing a resin lens plate according to claim 1 or 2, wherein;
said resin plate has a low-reflection film on a surface of it.

6. A method of manufacturing a resin lens plate according to claim 1 or 2, forming said convex micro-lenses by means of a hot-embossing method using a fixed metal mold and a movable metal mold each having spherical or aspherical micro-depressions arranged regularly at specified intervals on at least one surface of it.

7. A method of manufacturing a resin lens plate according to claim 6, wherein;
in order to selectively make the resin lens plate concave or convex in surface shape, the rate of cooling is changed or the difference in temperature is provided between said fixed metal mold and said movable metal mold.

8. A resin lens plate manufactured by a manufacturing method according to claim 1 or 2, said resin lens plate having spherical or aspherical convex micro-lenses arranged regularly at specified intervals on at least one surface of it, wherein the difference in percentage of contraction at both end portions in the short side direction in the middle in the long side direction of said plate is less than 0.1%.

9. An erecting resin lens array having at least two resin lens plates according to claim 8 arranged opposite to each other.

10. A resin lens plate manufactured by a manufacturing method according to claim 1 or 2, said resin lens plate having spherical or aspherical convex micro-lenses arranged regularly at specified intervals on at least one surface of it, wherein the difference in thickness at both end portions in the short side direction in both end portions in the long side direction of said plate is less than 1%.

11. An erecting resin lens array having at least two resin lens plates according to claim 10 arranged opposite to each other.
